(19) United States
(12) Patent Application Publication
(10) Pub. No.: US 2024/0160048 A1
(43) Pub. Date: May 16, 2024

(54) CONTACT LENS FOR TREATING COLOR VISION DEFICIENCY AND METHOD OF MANUFACTURING SAME

(71) Applicant: Khalifa University of Science and Technology, Abu Dhabi (AE)

(72) Inventors: Haider BUTT, Abu Dhabi (AE); Muhammed HISHAM, Abu Dhabi (AE); Abdelrahman Sakr, Abu Dhabi (AE)

(21) Appl. No.: 18/394,846

(22) Filed: Dec. 22, 2023

Related U.S. Application Data
(63) Continuation-in-part of application No. 17/499,251, filed on Oct. 12, 2021.
Application No. 17/499,251 is a continuation-in-part of application No. 17/307,316, filed on May 4, 2021, now Pat. No. 11,899,289.

(51) Int. Cl. G02C 7/10; B29C 64/124; B29C 64/188; B29C 64/314; B29C 64/35; B29D 11/00; B29K 33/00; B29K 105/00; B29L 11/00; B33Y 10/00; B33Y 70/00; B33Y 80/00; G02B 1/04; G02C 7/04

(52) U.S. Cl. CPC G02C 7/104; B29C 64/124; B29C 64/188; B29C 64/314; B29C 64/35; B29D 11/00038; B33Y 10/00; B33Y 70/00; B33Y 80/00; G02B 1/043; G02C 7/04; B29K 2033/08; B29K 2105/0032; B29K 2995/002; B29K 2995/0026; B29L 2011/0041

(57) ABSTRACT

A method of forming an ophthalmic contact lens may include the steps of preparing a first resin mixture including HEMA, PEGDA and a photoinitiator, preparing a second resin mixture including HEMA, PEGDA, a photoinitiator, and a pH sensitive dye, forming a first layer of the contact lens using an additive manufacturing apparatus by dispensing and curing the first resin mixture, and forming a second layer of the contact lens onto the first layer using the additive manufacturing apparatus by dispensing and curing the dispensed second resin mixture onto an outer surface of the first layer. A ratio of HEMA to PEGDA is higher in the second resin mixture than the first resin mixture and a volume of photoinitiator in the second resin mixture is less than the is less than a volume of photoinitiator in the second resin mixture. An ophthalmic contact lens configured to treat CVD is also provided.

### CROSS-REFERENCE TO RELATED APPLICATION

This is a continuation-in-part application and claims the benefit of U.S. patent application Ser. No. 17/499,251, titled “Method of Manufacturing Contact Lens for Treating Color Vision Deficiency”, and filed on Oct. 21, 2021, which is a continuation-in-part application and claims the benefit of U.S. patent application Ser. No. 17/307,316, titled “Contact Lens for Treating Color Vision Deficiency and Method of Manufacturing Same”, and filed on May 4, 2021, the entire disclosure of each of which is hereby incorporated by reference.

### TECHNICAL FIELD

This patent application is directed to a contact lens for treating various forms of color vision deficiency and method of manufacturing a contact lens.

### BACKGROUND

Human eyes see color via cone cells which are located in a 0.3 mm² spot of the retina near the back of the eye called the fovea centralis. There are three types of cone cells commonly referred to as blue, green and red photoreceptor cells. There are six to seven million cone cells in a human eye of which, 64% are red sensitive, 33% are green sensitive and 3% are blue sensitive.

Color vision deficiency (CVD) is caused when one or more of the cone types are faulty or absent due to mutation. This causes the brain to receive incomplete or incorrect information that prevents distinguishing between different colors. The type of CVD depends on the type of faulty or missing cone cell. Protanomaly results from the sensitivity of red cone cells being shifted to a shorter wavelength. This type of CVD affects 1.08% of males and 0.03% of females. Deuteranomaly occurs when the sensitivity of green cone cells is shifted to a longer wavelength. This is the most common form of CVD and affects 4.63% of males and 0.36% of females. In tritanomaly, the blue cone is dysfunctional. This type of CVD is uncommon and affects only 0.0002% of males. If a cone is missing, the patient is diagnosed as having dichromacy, which is classified into three types:
i) protanopia, where the red cone is missing which affects 1.01% of men and 0.02% of women,
ii) deuteranopia, where the green cones are missing and affecting 1.27% of men and 0.01% of women, and
iii) tritanopia, where the blue cones are missing.

Tritanopia is the most uncommon form of dichromacy and affects only 0.0001% of males. Protanomaly, deuteranomaly, protanopia and deuteranopia are all classified under the common term “red-green color blindness.” The most severe kind of CVD is the monochromacy which arises when no cones or only blue cones are present. This is extremely rare and affects 0.00003% of males and results in the inability to perceive any colors.

“Normal” color vision is trichromatic, with color being created using all three types of cones with the activation level in all three cones allowing the brain to determine the color. When light of a specific wavelength enters the eye, it excites the cones cells to a known activation level, and the combined signal from the different cone cells is analyzed by the brain and the color is observed. For example, when light of a wavelength of 520 nm is observed by normal individuals, the cones are activated at different levels: 0% for blue, 90% for green, and 55% for red. However, for protanomaly, the activation of the red cone cells to stimulation by 520 nm light is increased to 75% and for deuteranomaly, the activation of green cone cells is lowered to 60%. This causes the red and green cones to be activated to similar levels in protanomaly and deuteranomaly which results in the wrong color being perceived.

Despite the fact that many individuals have adapted to live with CVD, this condition affects them in many ways. In many countries, people who have CVD are not allowed to drive as some may not distinguish between the different colors of traffic lights and road signs. Suffering from CVD also prohibits individuals from entering some professions such as pilot or firefighter due to safety concerns over their visual disadvantage.

### SUMMARY

In some aspects, the techniques described herein relate to a method of manufacturing an ophthalmic contact lens, including:
a) preparing a first resin mixture including HEMA, PEGDA and a photoinitiator;
b) preparing a second resin mixture including HEMA, PEGDA, a photoinitiator, and a pH sensitive dye, wherein a ratio of HEMA to PEGDA is higher in the second resin mixture than the first resin mixture and a volume of photoinitiator in the second resin mixture is less than the is less than a volume of photoinitiator in the second resin mixture;
c) forming a first layer of the contact lens using an additive manufacturing apparatus by dispensing and curing the first resin mixture; and
d) forming a second layer of the contact lens onto the first layer using the additive manufacturing apparatus by dispensing and curing the dispensed second resin mixture onto an outer surface of the first layer.

In some aspects, the techniques described herein relate to an ophthalmic contact lens, including: a clear first region formed of a first material HEMA, PEGDA and a photoinitiator; and a dyed second region formed of second material containing HEMA, PEGDA, a photoinitiator, and a pH sensitive dye, wherein a ratio of HEMA to PEGDA is higher in the second resin mixture than the first resin mixture and a volume of photoinitiator in the second resin mixture is less than the is less than a volume of photoinitiator in the second resin mixture.

### DESCRIPTION OF THE DRAWINGS

Embodiments will now be described, by way of example with reference to the accompanying drawings, in which:

FIG. 1 is a front view of a contact lens having a tinted region according to some embodiments.

FIG. 2 is a front view of the contact lens of FIG. 1 disposed within an eye according to some embodiments.

FIG. 3 is a cross section view of the contact lens of FIG. 1 according to some embodiments.

FIG. 4 is a cross section view of a contact lens having two layers of the tinted regions containing different colored dyes according to some embodiments.

FIG. 5 is a flow chart of a method of forming the contact lenses of FIGS. 1-4, according to some embodiments.

FIG. 6 is a flow chart of a process of forming a contact lens using an additive manufacturing process according to some embodiments.

FIGS. 7A and 7B are a front views and side cross-section views respectively of contact lenses formed by an additive manufacturing process prior to dip coating according to some embodiments.

FIGS. 8A and 8B are the front views and side cross-section views respectively of the contact lenses of FIGS. 7A and 7B after dip coating according to some embodiments.

FIGS. 9A and 9B are a front views of the contact lenses formed by an additive manufacturing process according to some embodiments.

FIG. 10 is schematic view of an apparatus for forming a nanopattern on the surface of a contact lens according to some embodiments.

FIG. 11A is a front view of a contact lens with a nanopattern formed thereon according to some embodiments.

FIG. 11B is a close-up view of the nanopattern of FIG. 11A according to some embodiments.

FIG. 12 is a perspective view of a contact lens and support structures on a print bed of an additive manufacturing apparatus according to some embodiments.

FIG. 13A is a front view of a contact lens having two tinted regions according to some embodiments.

FIG. 13B is an isometric view of the contact lens of FIG. 13A according to some embodiments.

FIG. 14 is a cross-section view of the contact lens of FIG. 13A according to some embodiments.

FIG. 15 is a view of sequence of steps in a process of forming the contact lens of FIG. 13A according to some embodiments.

FIG. 16 is a flow chart of a process of forming the contact lens of FIG. 13A according to some embodiments.

FIG. 17 is a front view of a contact lens having a central dyed region and a pH sensitive dyed region according to some embodiments.

FIG. 18 is a cross-section view of the contact lens of FIG. 17 according to some embodiments.

FIG. 19 is a flow chart of a process of forming the contact lens of FIG. 17 according to some embodiments.

### DETAILED DESCRIPTION

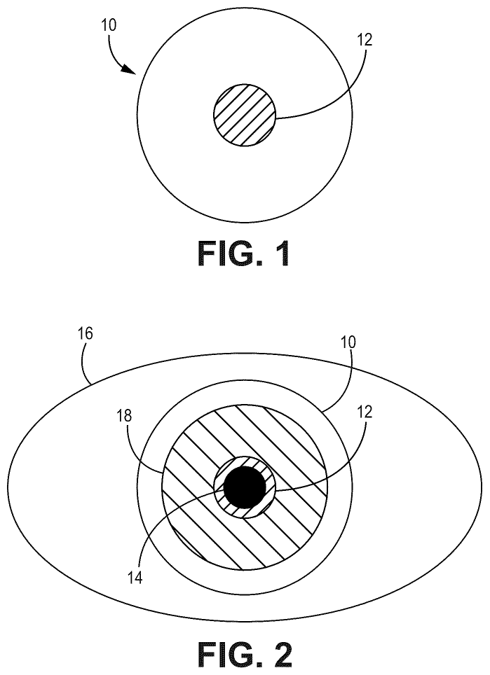

An ophthalmic contact lens that may be used to treat color vision deficiency (CVD) is described herein. As illustrated in FIGS. 1 and 2, the contact lens 10 has a tinted region 12 that is sized, shaped and arranged to cover the pupil 14 of the eye 16 in which the contact lens 10 is disposed. The tinted region 12 is preferably sized to cover the pupil 14 without covering a significant portion of the iris 18 surrounding the pupil so that it will not be easily noticeable that the contact lens wearer is using the contact lens 10 to treat CVD. Since the pupil 14 changes size depending on the intensity of incident light, the tinted region 12 may be sized to cover the pupil 14 for lower light intensity conditions in which cone vision is still active, but not necessarily cover the entire pupil 14 when vision is predominately rod based vision. The cones that sense the color on the retina are concentrated at the center of the fundus, that is, the central fovea and the surrounding elliptical shape, and the range corresponds to a viewing angle of about 10°. Since the radius of the cornea surface corresponding to this viewing angle of 10° is about 1.058 mm, a tinted portion having a diameter of about 2.1 mm is sufficient to correct CVD. The tinted region 12 may be sized so that it covers very little of the iris 18 so that it is not easily observable that the contact lens user is wearing a contact lens to treat CVD. The tinted region of the contact lens may cover less than 10% of the iris or less than 5% of the iris, for example.

The tinted region 12 includes a dye that is configured to block at least 50% of incident light in the 480-500 nanometer wavelength range to treat blue-yellow color blindness (tritanomaly and tritanopia). The tinted region 12 may also or alternatively include a dye that is configured to block at least 50%, and preferably 50 to 100%, of incident light in the 550 to 580 nanometer wavelength range to treat red-green color blindness. The percentage of light blocked by the dyes is dependent upon the particular needs of the contact lens wearer.

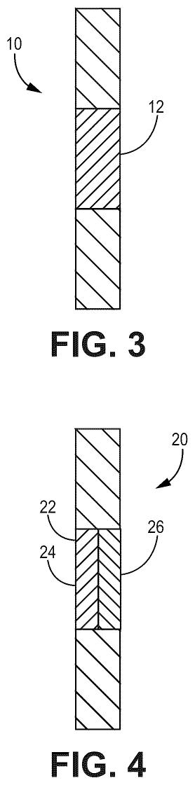

In one embodiment, the contact lens 10 is made of a 2-hydroxyethyl methacrylate (HEMA) material, which has a tinted region 12 shown in FIG. 3 that contains a first rhodamine dye having an absorption peak in the 505 to 515 nanometer wavelength range. This first rhodamine dye is a carboxytetramethylrhodamine dye, such as ATTO 488 manufactured by ATTO-TEC GmbH. The concentration of the dye is in the range of in the range of 0.000015% to 0.00003% by weight which is effective to block 50% to 100% of incident light in the 480 to 500 nanometer wavelength range. The contact lens 10 has an absorption peak in the 505 to 515 nanometer wavelength range. The first carboxytetramethylrhodamine dye is crosslinked with the HEMA material to provide a stable tinted region from which the dye will not leach into the eye or into a phosphate buffered saline contact lens storage solution. Carboxytetramethylrhodamine dyes are considered nontoxic for corneal cells. The shift in the absorption peak in the contact lens 10 to the 505 to 515 nanometer wavelength range is caused by the cross linking of the first carboxytetramethylrhodamine dye with the HEMA material.

In a second embodiment, the contact lens 10 is made of HEMA material and has a tinted region 12 shown in FIG. 3 that contains a second rhodamine dye having an absorption peak at 500 nanometers. This second rhodamine dye is a carboxytetramethylrhodamine dye, such as ATTO 565 also manufactured by ATTO-TEC GmbH. The concentration of the dye is in the range of 0.000015% to 0.00003% by weight which is effective to block 50% to 100% of incident light in the 550 to 580 nanometer wavelength range. The contact lens 10 has an absorption peak in the 560 to 570 nanometer wavelength range. The second carboxytetramethylrhodamine dye is crosslinked with the HEMA material to provide a stable tinted region from which the dye will not leach into the eye, or a phosphate buffered saline contact lens storage solution.

In a third embodiment, the contact lens 20 has a tinted region 22 with two distinct layers 24, 26 as shown in FIG. 4. The first layer formed of a HEMA material with a first dye concentration effective to block 50% to 100% of incident light in the 480-515 nanometer wavelength range and a second layer formed of a HEMA material with a second dye concentration which is effective to block 50% to 100% of incident light in the 550 to 580 nanometer wavelength range. The contact lens 20 has two distinctive dips in its spectra transmitted through the contact lens 20 at wavelengths of 495 nm and 565 nm. In an alternative embodiment, the first layer formed of a HEMA material with a first dye concentration effective to block 50% to 100% of incident light in the 550 to 580 nanometer wavelength range and a second layer formed of a HEMA material with a second dye concentration which is effective to block 50% to 100% of incident light in the 480-515 nanometer wavelength range.

The first and second contact lenses 10 may be made using a method of mixing a solution comprising polyethylene glycol dimethacrylate (PEGDA), 2-hydroxyethyl methacrylate (HEMA), and 2,2-dimethoxy-2-phenylacetophenone (photoinitiator) with the first or second carboxytetramethylrhodamine dye. The ratio of the HEMA to PEGDA to photoinitiator is in the range of 20:1:1 to 10:10:1, by volume. The concentration of the carboxytetramethylrhodamine dye is in the range of in the range of 0.000015% to 0.00003% by weight. The mixture is then poured into a mold and the cured by exposure to an ultraviolet light source. The light source may provide energy in the range of 100 to 1200 μJ/cm2 at a wavelength of 365 nm. The mixture may be exposed to the ultraviolet light for a period of 2 to 30 minutes in order to cure the mixture.

In another embodiment, the two dyes are added in certain proportions into the mixture (comprising polyethylene glycol dimethacrylate (PEGDA), 2-hydroxyethyl methacrylate (HEMA), and 2,2-dimethoxy-2-phenylacetophenone and then formed into a lens with a single layer rather two separate layers, one for each dye.

The third contact lens 20 may be made by adding the steps of mixing another solution comprising polyethylene glycol dimethacrylate (PEGDA), 2-hydroxyethyl methacrylate (HEMA), and 2,2-dimethoxy-2-phenylacetophenone (photoinitiator) with whichever carboxytetramethylrhodamine dye was not used previously. The ratio of the HEMA to PEGDA to photoinitiator is in the range of 20:1:1 to 10:10:1, by volume. The concentration of the carboxytetramethylrhodamine dye is in the range of in the range of 0.000015% to 0.00003% by weight. The mixture is then poured into the mold over the previously formed layer and the cured by exposure to an ultraviolet light source. The light source may provide energy in the range of 100 to 1200 μJ/cm2 at a wavelength of 365 nm. The mixture may be exposed to the ultraviolet light for a period of 2 to 30 minutes in order to cure the mixture.

Alternatively, the contact lenses 10, 20, may be formed by an additive manufacturing (3D printing) process using a digital light processor printer having an ultraviolet light source and containing the solutions as described above.

The tinted area of the contact lens is stable when stored a hydroxypropyl methylcellulose (artificial tears) solution, such as TEARS NATURALE™ II manufactured by Alcon, or when stored in a phosphate buffered saline solution, such as ACUVUE™ REVITALENS® solution manufactured by Johnson & Johnson, for a period of at least one week.

Testing performed with deuteranopia subjects using the contact lenses 10 with the first dye to block 90% of light in the 480 to 500 nanometer wavelength range experienced 15% improvement in correctly identifying plates in the Ishihara test commonly used to evaluate CVD, while the contact lenses 10 with the second dye to block 90% of light in the 550 to 580 nanometer wavelength range provided about 20% improvement and the contact lens 20 provided about 23% improvement. Testing performed with deuteranomaly subjects using the contact lenses 10 with the first dye experienced a decrease of about 5% in correctly identifying plates in the Ishihara test while the contact lens 10 with the second dye provided about 11% improvement and the contact lens 20 provided about 25% improvement.

While the contact lenses 10, 20 described above are hydrogel contact lenses formed primarily from HEMA material, alternative contact lenses including the inventive features may be silicon hydrogel or hard contact lenses with a thin layer of HEMA material containing the tinted region described above.

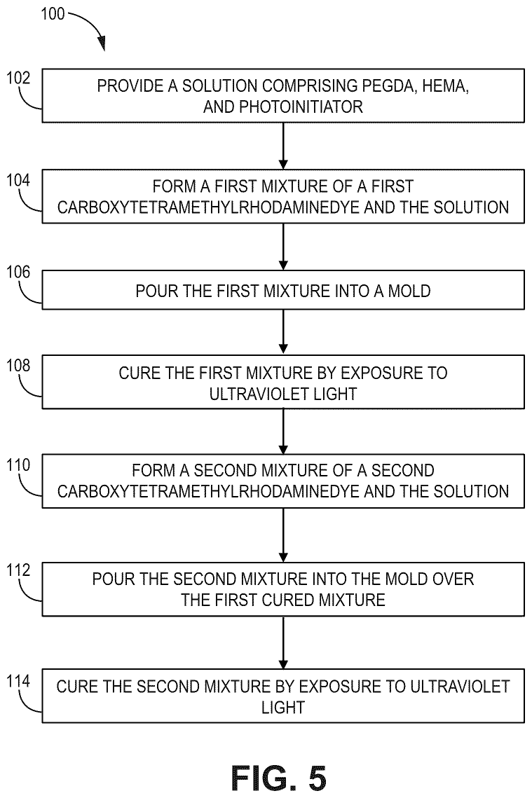

A method 100 of forming a contact lens 10 with a tinted region 12 configured to treat CVD is shown in FIG. 5. The method 100 includes the steps of:

STEP 102, PROVIDE A SOLUTION COMPRISING PEGDA, HEMA, AND PHOTOINITIATOR, includes providing a solution that includes 2-hydroxyethyl methacrylate (HEMA), polyethylene glycol dimethacrylate (PEGDA), and a photoinitiator, e.g., 2,2-dimethoxy-2-phenylacetophenone;

STEP 104, FORM A FIRST MIXTURE OF A FIRST CARBOXYTETRAMETHYLRHODAMINE DYE AND THE SOLUTION includes forming a first mixture of a first carboxytetramethylrhodamine dye and the solution of HEMA, PEGDA, and the photoinitiator;

STEP 106, FORM THE FIRST MIXTURE INTO A DESIRED SHAPE, includes forming the first mixture into a desired shape by pouring the mixture in to a mold shaped to form the contact lens 10 or using an additive manufacturing process;

STEP 108, CURE THE FIRST MIXTURE BY EXPOSURE TO ULTRAVIOLET LIGHT, includes curing the first mixture in the mold by exposure to ultraviolet light, e.g., ultraviolet light with a wavelength of 365 nm having an intensity in the range of 100 to 1200 μJ/cm2 for a period of 2 to 30 minutes or by using a digital light processor 3D printer having an ultraviolet light source;

STEP 110, FORM A SECOND MIXTURE OF A SECOND CARBOXYTETRAMETHYLRHODAMINE DYE AND THE SOLUTION, is an optional step in forming the contact lens 20 that includes forming a second mixture of a second carboxytetramethylrhodamine dye and the solution of HEMA, PEGDA, and the photoinitiator;

STEP 112, FORM THE SECOND MIXTURE INTO A DESIRED SHAPE OVER THE FIRST CURED MIXTURE, is an optional step in forming the contact lens 20 that includes pouring the second mixture into the mold over the first cured mixture that remains in the mold to form a desired shape of the second mixture or forming the second mixture into a desired shape over the first cured mixture using an additive manufacturing process; and

STEP 114, CURE THE SECOND MIXTURE BY EXPOSURE TO ULTRAVIOLET LIGHT, is an optional step in forming the contact lens 20 that includes curing the second mixture by exposure to ultraviolet light, e.g., ultraviolet light with a wavelength of 365 nm having an intensity in the range of 100 to 1200 μJ/cm2 for a period of 2 to 30 minutes or by using a digital light processor 3D printer having an ultraviolet light source.

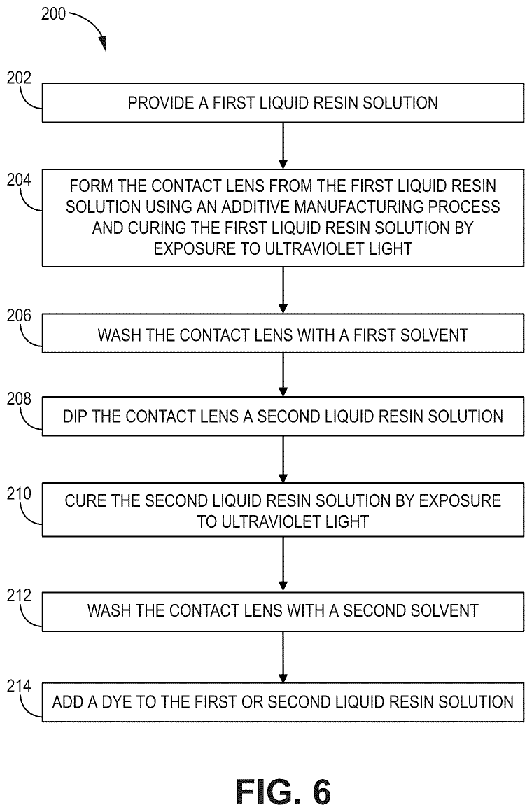

A process 200 of forming a contact lens 10 with a tinted region 12 configured to treat CVD using an additive manufacturing process, commonly known as a 3D printing process, is shown in FIG. 6. The process 200 includes the steps of:

STEP 202, PROVIDE A FIRST LIQUID RESIN SOLUTION, includes providing a first liquid resin solution. Two examples of a suitable first resin solution are a first mixture of 2-hydroxyethyl methacrylate (HEMA), polyethylene glycol dimethacrylate (PEGDA), and a photoinitiator such as 2,2-dimethoxy-2-phenylacetophenone or diphenyl (2,4,6-trimethylbenzoyl) phosphine oxide (TPO). The ratio of HEMA to PEGDA may be in a range of 3:1 to 1:1 and the concentration of the photoinitiator may be in the range of 2% to 10% by weight of the solution. In one example, the ratio of HEMA to PEGDA is 1:1 and the concentration of the photoinitiator is 2.5% by weight. The composition of the solution has been found to optimize the optical transmittance of the contact lens 10;

STEP 204, FORM THE CONTACT LENS FROM THE FIRST LIQUID RESIN SOLUTION USING AN ADDITIVE MANUFACTURING PROCESS AND CURING THE FIRST LIQUID RESIN SOLUTION BY EXPOSURE TO ULTRAVIOLET LIGHT, includes loading the first liquid resin solution into an additive manufacturing device, such as a digital light printer (DLP) or a masked stereolithography apparatus (MSLA) that is programmed to form the lens shape of the contact lens 10 and any removeable support structures 44 needed during the process of forming the contact lens as shown in FIG. 12. The contact lens 10 is then formed from the first liquid resin solution using the additive manufacturing process. DLP and MSLA provide higher resolution of printing and reduced thickness of the printed layers over other additive manufacturing processes, such as selective laser sintering (SLS) and fused deposition modeling (FDM). The thickness of the layers forming the support structures 44 and lens 10 may vary from 25 to 100 micron. It was found that the layers forming the lens 10 are preferably about 25 micron to reduce the “stair-step” at the edges of each layer. The lens 10 may be formed such that the disc of the lens is generally perpendicular to the print bed 46 of the additive manufacturing device on which the support structures 44 are formed as illustrated in FIG. 12. It was found that forming the lens 10 with this orientation to the print bed produced the smoothest lens surface and provided a smaller support structure 44, thereby minimizing the material used to form the support structures 44 that will eventually be removed from the lens and discarded. The support structures 44 are typically limited to 5 layers, also to minimize discarded material. Each layer is cured by exposure to ultraviolet light, e.g., ultraviolet light with a wavelength of 365 nm having an intensity in the range of 100 to 1200 μJ/cm² for a period of 15 to 35 seconds. The optimal cure time for the support structures 44 was found to be in a range of 30 to 35 seconds and the optimal cure time for the lens 10 was found to be in a range of 15 to 20 seconds;

STEP 206, WASH THE CONTACT LENS WITH A FIRST SOLVENT TO REMOVE UNCURED FIRST LIQUID RESIN SOLUTION AFTER CURING THE FIRST LIQUID RESIN SOLUTION BY EXPOSURE TO ULTRAVIOLET LIGHT, is an optional step including washing the contact lens with a first solvent, e.g., isopropyl alcohol, to remove any remaining portions of the first liquid resin solution that remain uncured after exposing the first liquid resin solution to ultraviolet light;

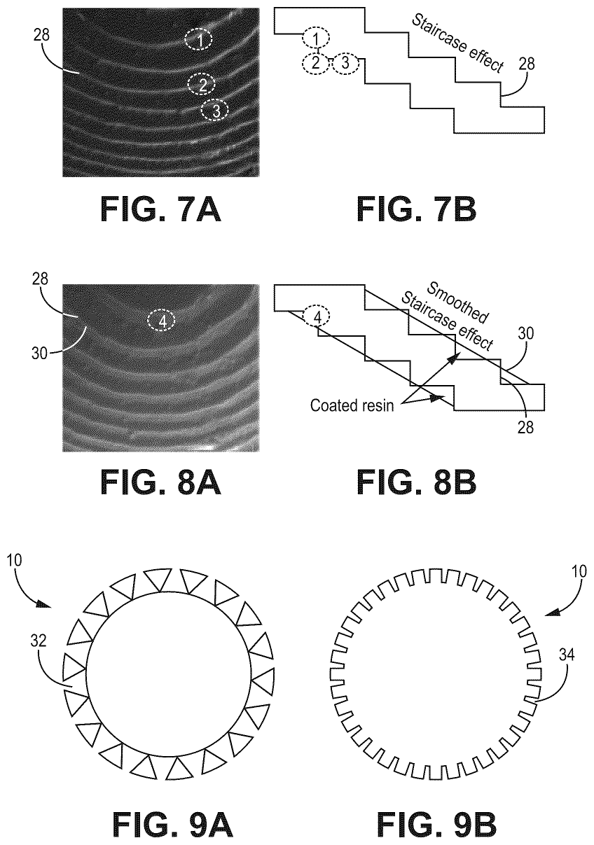

STEP 208, DIP THE CONTACT LENS FORMED BY THE ADDITIVE MANUFACTURING PROCESS INTO A SECOND LIQUID RESIN SOLUTION, includes dip coating the contact lens that was formed by the additive manufacturing process by submerging the contact lens in a second liquid resin solution for a period of 30 seconds to one minute. The second liquid resin solution may be the same as the first resin solution. FIGS. 7A and 7B show stair step features 28 that are created between the layers forming the contact lens. The inventors have found that dipping the contact lens in the second liquid resin solution 30 reduces and fills in stair step features 28 at the edges of the layers as shown in FIGS. 8A and 8B, thereby improving surface smoothness and performance of the contact lens. The inventors discovered that post processing the context lens by dip coating improves optical transmittance of the resulting contact lens by about 30%;

STEP 210, CURE THE SECOND LIQUID RESIN SOLUTION BY EXPOSURE TO ULTRAVIOLET LIGHT, includes curing the second liquid resin solution by exposure to ultraviolet light for a period of one to two minutes;

STEP 214 WASH THE CONTACT LENS WITH A SECOND SOLVENT TO REMOVE UNCURED SECOND LIQUID RESIN SOLUTION AFTER CURING THE SECOND LIQUID RESIN SOLUTION BY EXPOSURE TO ULTRAVIOLET LIGHT, is an optional step including washing the contact lens with a second solvent which may be the same as the first solvent, e.g., isopropyl alcohol, to remove any remaining portions of the second liquid resin solution that remain uncured after exposing the second liquid resin solution to ultraviolet light; and

STEP 212, ADD A FIRST DYE OR A SECOND DYE TO THE FIRST OR SECOND LIQUID RESIN SOLUTION, is an optional step that includes adding a first dye configured to absorb at least 50% of incident light in a spectral band between 480 nanometers to 500 nanometers or a second dye configured to absorb at least 50% of incident light in a spectral band between 550 nanometers to 580 nanometers to the first or second liquid resin solution so that the contact lens may be used to treat CVD. The dyes may be a carboxytetramethylrhodamine dye when the first or second liquid resin solution is a mixture of HEMA, PEGDA, and 2,2-dimethoxy-2-phenylacetophenone or a food grade dye when the first or second liquid resin solution is a mixture of HEMA, PEGDA, and TPO. The carboxytetramethylrhodamine dyes are added to have a concentration of 0.000015% to 0.00003% by weight while the food grade dyes are added to have a concentration of about 2% by volume.

The additive manufacturing process may also be used to form rectangular microchannels 32, as shown in FIG. 9A, or triangular microchannels 34 as shown in FIG. 9B, at the edge of the contact lens 10. These microchannel 32 and 34 may act as optical transducers by observing a change in the microchannel geometries with the help of images captured by a camera, e.g., a smart phones camera. For example, dry eye sensing can be performed by monitoring the spacing between or shape of the microchannels 32, 34.

The inventors have also discovered that the surface finish and optical transmittance of the contact lens formed by the additive manufacturing process may be further improved by placing a thin film of PVC plastic on top of the print bed of the additive manufacturing apparatus thereby allowing easier removal of the contact lens from the print bed and a reduction in damage to the contact lens while removing it from the print bed.

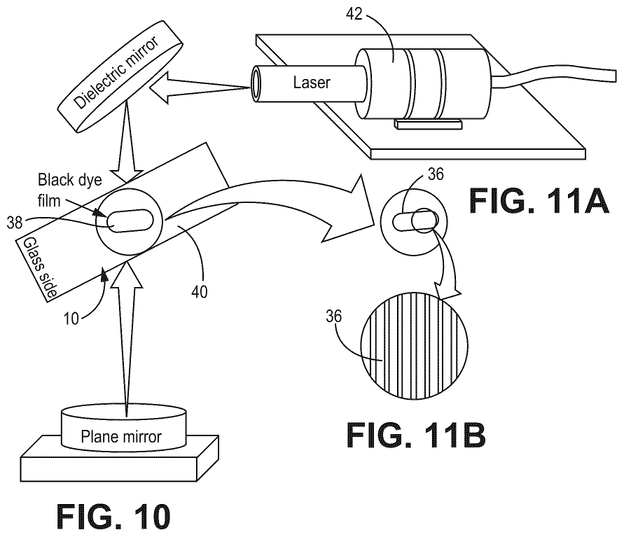

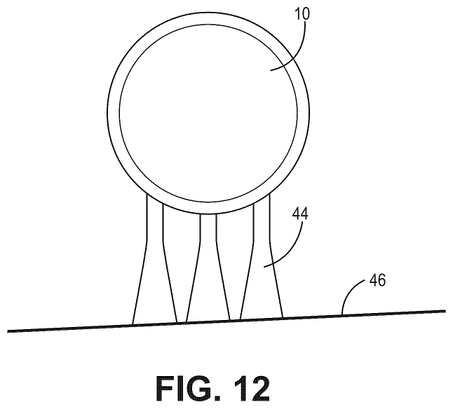

A nanopattern 36 may be formed on the surface of the contact lens via a holographic laser ablation apparatus as shown in FIG. 10. The holographic nanopattern 36 integrated on the contact lens 10 shown in FIGS. 11A and 11B can be utilized as a transducer to sense electrolyte concentration in the tears, which may indicate a physiological state of the eye. Sensing the electrolyte concentration in tears could provide early detection of disease conditions in the eye.

The laser ablation process is conducted via direct laser interference patterning (DLIP) method in holographic Denisyuk reflection mode. To facilitate the interaction between the laser beams and the lens material, a black color dye 38 is placed on the surface of the contact lens.

The process of producing the nanopattern on the lens material may include the following steps:
a) cleaning the contact lens 10 with isopropyl alcohol and placing it on a glass slide 40;
b) applying a laser absorbing film 38, e.g., a synthetic black dye to the surface of the contact lens 10;
c) generating the holographic nanopattern 36 on the contact lens 10 due to the interference between the incident and reflected laser beams.

Upon exposure to the laser 42, the ablative interference fringes are developed thereby forming a one-dimensional (1D) nanopattern 36 on the surface of the 3D printed contact lens 10.

Because of the high energy in the constructive interference regions, the nanogrooves are produced on the surface of the contact lens as shown in the FIG. 11B. A high-power interference beam is produced when incident beam and reflected beam interact and result in ablation of the surface of the contact lens 10. The grating spacing depends on the angle of exposure. For example, a grating spacing of 925 nm can be created at an exposure angle of 35° from the horizontal plane.

Accordingly, contact lenses 10, 20 configured for treating CVD and a method 100 and process 200 for manufacturing these contact lenses 10, 20 is presented herein. The use of using a dyed region to block out light with undesirable wavelengths, instead of quantum dots or nanoparticles, provides a lower cost and simplicity which make the contact lenses 10, 20 ideal for mass production. In addition, the carboxytetramethylrhodamine dye is nontoxic to the corneal tissue of the eye. Once the carboxytetramethylrhodamine dye is cross-linked with the HEMA material forming the lens, it is resistant to leaching into tears in the eye or contact lens storage solution, thereby providing a stable color in the tinted regions, 12, 22. It has also been found that crosslinking the carboxytetramethylrhodamine dye with the HEMA material does not affect the dye's chemical structure. In addition, the carboxytetramethylrhodamine dye has high thermal stability, high photostability, and is slightly hydrophilic.

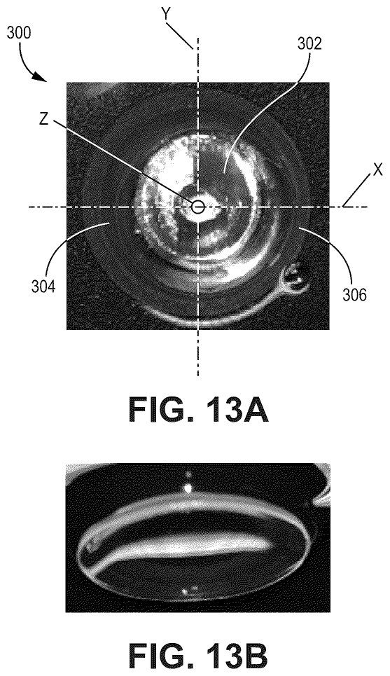

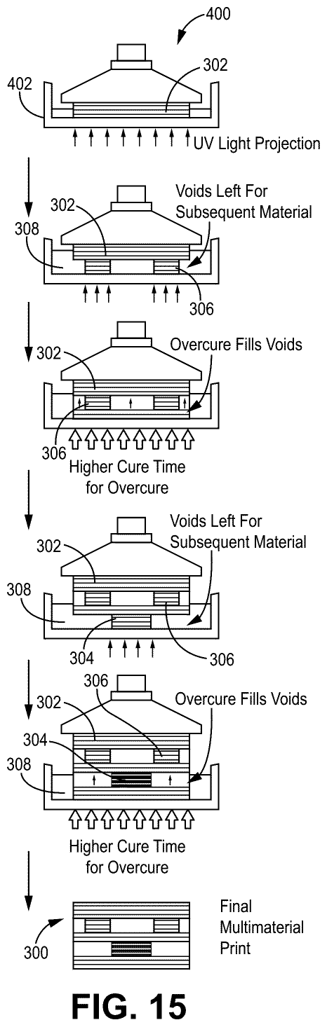

Another example of an ophthalmic contact lens 300 that may be used to treat color vision deficiency (CVD) is also described herein. As illustrated in FIGS. 13A and 13B, the contact lens 300 has a clear central region 302 that is sized, shaped and arranged to cover the pupil of the eye in which the contact lens 300 is disposed. As used herein, the term “clear central region” means that this region is configured to transmit over 90% of incident visible light, i.e., light within in a spectral band having a frequency of 380 nanometers to 700 nanometers. The clear central region 302 is circumferentially surrounded by an annular first tinted region 304. An annular second tinted region 306 is coaxial with the first tinted region 304 and also surrounds the clear central region 302. The first and second tinted regions 304, 306 are substantially non-overlapping along a principal axis Z of the ophthalmic contact lens. As used herein, substantially non-overlapping means that an overlap area of the first and seconds tinted regions 304, 306 is less than or equal to 5% of the first and seconds tinted regions 304, 306. The first tinted region 304 is also offset along the principal axis Z from the second tinted layer due to the first and second tinted regions being formed as separate layers by an additive manufacturing process as shown in FIG. 15.

The first tinted region 304 has a distinct color from the second tinted region 306. In the illustrated examples, the first tinted region 304 is tinted to have a pinkish color to treat red-green color blindness and the second tinted region 306 is tinted to have a yellow-green color to treat blue-yellow color blindness.

The clear region 302, the first tinted region 304, and the second tinted region 306, are all formed of materials containing 2-hydroxyethyl methacrylate (HEMA), polyethylene glycol dimethacrylate (PEGDA), and 2,2-dimethoxy-2-phenylacetophenone. In this example, the first tinted region 304 further includes a first dye configured to absorb 50% to 99% of incident light in a spectral band of 480 nanometers to 500 nanometers with an absorption peak of 500 nanometers and the second tinted region 306 includes a second dye configured to absorb 50% to 99% of incident light in a spectral band of 550 nanometers to 580 nanometers with an absorption peak of 564 nanometers. In the examples presented herein, the first and second dyes are carboxytetramethylrhodamine dyes, such as ATTO 488 and ATTO 565 referenced above. The carboxytetramethylrhodamine dyes have a concentration in the material forming the ophthalmic contact lens within a range of 0.000015% to 0.00003% by weight and are copolymerized with the HEMA material.

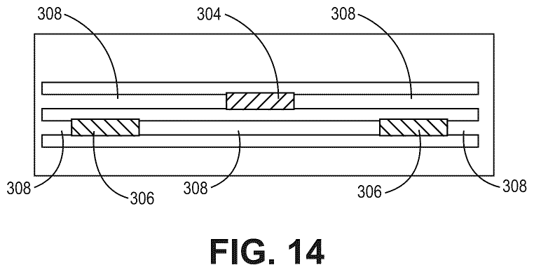

The contact lens 300 may be formed by an additive manufacturing process using an additive manufacturing machine such as a 3D printer 400 as shown in FIG. 15. A CAD model of the contact lens 300 including the clear region 302, first tinted region 304, and second tinted region 306 may be prepared using a software program, such as SOLIDWORKS. Each of the regions formed of a different material are modeled as a subsequent section along the principal axis Z of the contact lens 300, leaving voids 308 where intra-layer material change is required as shown in FIG. 14. This is done so that a longer curing time can be used while printing to cause material formation on the subsequent section and to fill the voids 308. This process is discussed in more detail below.

The CAD model is converted to instructions for the 3D printer 400, e.g., a WANHAO D8DLP-based 3D printer manufactured by WANHAO of Zhejiang, Peoples Republic of China. The process settings for the 3D printer 400 contained in Table 1 may be used to create the contact lens 300.

TABLE 1
Process Settings for 3D Printer

| Printing Parameters | Specifications | |
|---|---|---|
| Layer thickness | 35 | μm |
| Curing time | Burn layers-80 s | |
| | Normal layers-25 s | |
| Burn layer count | 5 | layers |
| Lift distance | 6 | mm |
| Lift speed | 50 | mm/min |
| Retract speed | 50 | mm/min |

For printing the contact lens 300, the 3D printer 400 was paused at the required time steps. Pausing causes the printing process to stop. The build plate 402 of the 3D printer 400 is raised to allow access to the in-process contact lens 300. The liquid resin in the vat is removed and replaced by a different resin. The in-process contact lens 300 sticking onto the build plate 402 is also cleaned to remove traces of resin sticking onto it. The in-process contact lens 300 is cleaned to prevent mixing of previously used material with the new material poured into the vat. The in-process contact lens 300 should be cleaned very carefully, as rough handling can cause it to detach from the build plate 402. The in-process contact lens 300 may be cleaned by running isopropyl alcohol (IPA) over it and then wiping it dry. The printing process was then resumed, thus causing the contact lens 300 to be printed with two dyed resins. The contact lens 300 may be removed from the build plate 402 and cleaned using a sonication process for 20 min while immersed in IPA. The sonication process removes traces of uncured resin that may still be attached to the contact lens 300, making the surfaces of the contact lens 300 smooth and clean. Thorough cleaning after printing greatly improved the contact lens' 300 optical transmission, which is crucial for ophthalmic devices.

A cure time of 100 seconds is used at specific points while printing the contact lens 300 to make use of the overcure effect. By establishing different materials as separate sections along the principal axis, the regions where another subsequent material is needed are left as voids. The longer cure time, e.g., 100 seconds may polymerize the subsequent material within the voids left behind in the previously printed sections. Thus, the contact lens 300 is printed as a continuous piece without voids but possessing variations in material in the plane perpendicular, i.e., the x-y plane, to the z axis. Enabling the material change across the x-y plane was not previously achievable because previously standard DLP multi-material printing only allowed a material change along the principal axis. Material change within the x-y plane was not possible in standard multi-material printing because of the layer-by-layer printing scheme, which restricts material change from occurring only on subsequent layers. It is impossible to return to a previously printed layer and deposit another material in it. However, suitable voids in initial layers and high cure times (in the following layers), allow materials from subsequent layers to flow back into the voids in the initial layers and be properly cured through overcuring.

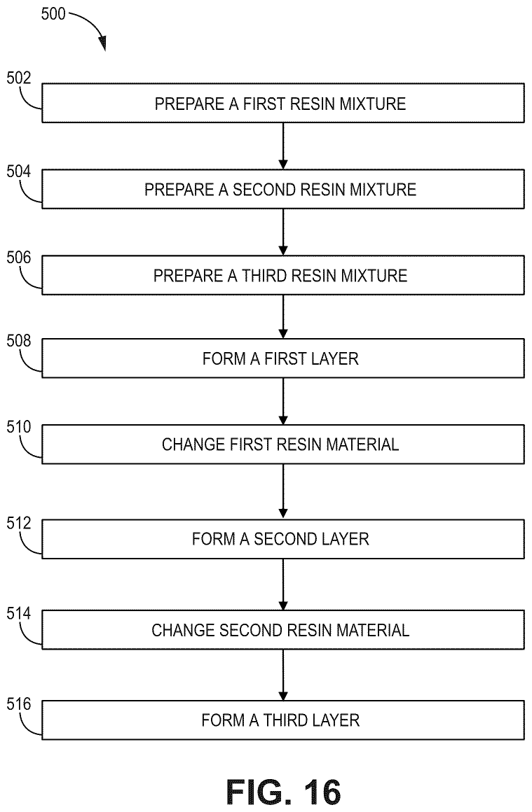

A method 500 of manufacturing an ophthalmic contact lens 300 using an additive manufacturing process is shown in FIG. 16. The method 500 includes the steps of:

STEP 502, PREPARE A FIRST RESIN MIXTURE, includes preparing a first resin mixture for forming the central clear region 302 including HEMA, PEGDA, and 2,2-dimethoxy-2-phenylacetophenone. The first resin mixture is configured to transmit over 90% of incident light in a spectral band ranging from 380 nanometers to 700 nanometers. This mixture may also be used to fill any voids created during the additive manufacturing process.

STEP 504, PREPARE A SECOND RESIN MIXTURE, includes preparing a second resin mixture including the first resin mixture and a first dye. The second resin mixture is used to form the first tinted region 304. The first dye may have an absorption peak of 500 nanometers. The first dye may be a carboxytetramethylrhodamine dye having a concentration in the second resin mixture in a range of 0.000015% to 0.00003% by weight.

STEP 506, PREPARE A THIRD RESIN MIXTURE, includes preparing a third resin mixture including the first resin mixture and a second dye distinct from the first dye. The second resin mixture is used to form the second tinted region 306. The second dye may have an absorption peak of 564 nanometers. The second dye may be a carboxytetramethylrhodamine dye having a concentration in the third resin mixture in a range of 0.000015% to 0.00003% by weight.

STEP 508, FORM A FIRST LAYER, includes forming a first layer, e.g., the clear region 302 of the contact lens 300, using an additive manufacturing apparatus. e.g., the 3D printer 400 by dispensing and curing the first resin mixture. When cured to form the first layer, the first resin mixture may be configured to transmit over 90% of incident light in a spectral band ranging from 380 nanometers to 700 nanometers.

STEP 510, CHANGE FIRST RESIN MATERIAL, includes pausing the additive manufacturing apparatus, cleaning the first layer, and replacing the first resin mixture with the second resin mixture.

STEP 512, FORM A SECOND LAYER, includes forming a second layer of the contact lens, e.g., the first tinted region 304, using the additive manufacturing apparatus by dispensing and curing the second resin mixture such that the second layer circumferentially encircles and is substantially non-overlapping with the first layer along a principal axis Z of the contact lens 300. When cured, the second resin mixture forming the second layer may be configured to absorb 50% to 99% of incident light in a spectral band of 550 nanometers to 580 nanometers.

STEP 514, CHANGE SECOND RESIN MATERIAL, includes pausing the additive manufacturing apparatus, cleaning the second layer, and replacing the second resin mixture with the third resin mixture.

STEP 516, FORM A THIRD LAYER, includes forming a third layer of the contact lens 300, e.g., the second tinted region 306 from the third resin mixture using the additive manufacturing apparatus by dispensing and curing the third resin mixture such that the third layer circumferentially encircles and is substantially non-overlapping with the second layer along the principal axis X of the contact lens 300. The second layer has a color that is distinct from the third layer. When cured, the third resin mixture forming the third layer is configured to absorb 50% to 99% of incident light in a spectral band of 480 nanometers to 500 nanometers.

A remainder of the contact lens 300 outside of the second and third layers may be formed of the first resin mixture. The first resin mixture may flow into voids formed in the contact lens 300 as the first, second, and third layers are formed and then this first resin mixture is cured.

While the contact lens 300 illustrated herein includes two different tinted regions, alternative embodiments of the contact lens may be envisioned that include a single tinted region or three or more tinted regions.

While the method 500 illustrated herein is employed to manufacture a contact lens 300, alternative embodiments of the method may be envisioned to manufacture other products or devices using an additive manufacturing apparatus.

While the contact lenses described herein are hydrogel contact lenses formed primarily from HEMA material, alternative embodiments may be silicon hydrogel or hard contact lenses with a thin layer of HEMA material containing the tinted regions described above.

In some respects, the techniques described herein relate to a method 500 of manufacturing an ophthalmic contact lens 300, including the steps of:
(a) preparing a first resin mixture including HEMA, PEGDA, and 2,2-dimethoxy-2-phenylacetophenone;
(b) preparing a second resin mixture including the first resin mixture and a first dye;
(c) preparing a third resin mixture including the first resin mixture and a second dye distinct from the first dye;
(d) forming a first layer of the ophthalmic contact lens using an additive manufacturing apparatus by dispensing and curing the first resin mixture;
(e) forming a second layer of the ophthalmic contact lens using the additive manufacturing apparatus by dispensing and curing the second resin mixture such that the second layer circumferentially encircles and is substantially non-overlapping with the first layer along a principal axis of the ophthalmic contact lens; and
(f) forming a third layer of the ophthalmic contact lens from the third resin mixture using the additive manufacturing apparatus by dispensing and curing the third resin mixture such that the third layer circumferentially encircles and is substantially non-overlapping with the second layer along the principal axis of the ophthalmic contact lens. The second layer has a color that is distinct from the third layer.

In some respects, the techniques described herein relate to a method 500, further including the steps of:
(g) pausing the additive manufacturing apparatus, cleaning the first layer, and replacing the first resin mixture with the second resin mixture between steps d) and e); and
(h) pausing the additive manufacturing apparatus, cleaning the second layer, and replacing the second resin mixture with the third resin mixture between steps e) and f).

In some respects, the techniques described herein relate to a method 500, wherein, when cured, the first resin mixture is configured to transmit over 90% of incident light in a spectral band ranging from 380 nanometers to 700 nanometers.

In some aspects, the techniques described herein relate to a method 500, wherein, when cured, the second resin mixture is configured to absorb 50% to 99% of incident light in a spectral band of 550 nanometers to 580 nanometers and wherein, when cured, the third resin mixture is configured to absorb 50% to 99% of incident light in a spectral band of 480 nanometers to 500 nanometers.

In some respects, the techniques described herein relate to a method 500, wherein the first dye has an absorption peak of 500 nanometers and the second dye has an absorption peak of 564 nanometers.

In some respects, the techniques described herein relate to a method 500, wherein the first and second dyes are carboxytetramethylrhodamine dyes having a concentration in the second and third resin mixtures in a range of 0.000015% to 0.00003% by weight.

In some respects, the techniques described herein relate to a method 500, wherein a remainder of the ophthalmic contact lens outside of the second and third layers is formed of the first resin mixture.

In some respects, the techniques described herein relate to a method 500, wherein the first resin mixture flows into voids in the first, second, and third layers and is cured.

In some respects, the techniques described herein relate to a method 500, wherein a first curing time required to cure the first, second, and third layers is less than a second curing time required to cure the first resin mixture in the voids.

In some respects, the techniques described herein relate to an ophthalmic contact lens 300, including: a first tinted region; and a second tinted region. The first tinted region and the second tinted region are substantially non-overlapping along a principal axis of the ophthalmic contact lens. The first tinted region has a distinct color from the second tinted region.

In some respects, the techniques described herein relate to an ophthalmic contact lens 300, wherein the second tinted region is coaxial with the first tinted region.

In some respects, the techniques described herein relate to an ophthalmic contact lens 300, further including a clear region. The first tinted region is annular and circumferentially surrounds the clear region. The second tinted region is annular and is coaxial with the first tinted region.

In some respects, the techniques described herein relate to an ophthalmic contact lens 300, wherein the clear region is configured to transmit over 90% of incident light in a spectral band of 380 nanometers to 700 nanometers.

In some respects, the techniques described herein relate to an ophthalmic contact lens 300, wherein the first tinted region, the second tinted region, and the clear region each include 2-hydroxyethyl methacrylate (HEMA), polyethylene glycol dimethacrylate (PEGDA), and 2,2-dimethoxy-2-phenylacetophenone.

In some aspects, the techniques described herein relate to an ophthalmic contact lens 300, wherein the first tinted region includes a first dye configured to absorb 50% to 99% of incident light in a spectral band of 480 nanometers to 500 nanometers and the second tinted region includes a second dye configured to absorb 50% to 99% of incident light in a spectral band of 550 nanometers to 580 nanometers.

In some aspects, the techniques described herein relate to an ophthalmic contact lens 300, wherein the first and second tinted regions each include a dye selected from a list consisting of a first dye configured to absorb 50% to 99% of incident light in a spectral band of 480 nanometers to 500 nanometers and a second dye configured to absorb 50% to 99% of incident light in a spectral band of 550 nanometers to 580 nanometers.

In some respects, the techniques described herein relate to an ophthalmic contact lens 300, wherein the first dye has an absorption peak of 500 nanometers and the second dye has an absorption peak of 564 nanometers.

In some aspects, the techniques described herein relate to an ophthalmic contact lens 300, wherein the first tinted region and the second tinted region each include a dye selected from a list consisting of a first carboxytetramethylrhodamine dye having a concentration in a material within a range of 0.000015% to 0.00003% by weight and configured to absorb at least 50% of incident light in a spectral band between 480 nanometers to 500 nanometers and a second carboxytetramethylrhodamine dye having a concentration in a material within the range of 0.000015% to 0.00003% by weight and configured to absorb at least 50% of incident light in a spectral band between 550 nanometers to 580 nanometers.

In some respects, the techniques described herein relate to an ophthalmic contact lens 300, wherein the first carboxytetramethylrhodamine dye has an absorption peak of 500 nanometers and the second carboxytetramethylrhodamine dye has an absorption peak of 564 nanometers.

In some respects, the techniques described herein relate to an ophthalmic contact lens 300, wherein at least one of the first and second carboxytetramethylrhodamine dyes is copolymerized with HEMA.

Yet another example of an ophthalmic contact lens 600 that may be used to treat color vision deficiency (CVD) and also indicate acidity or alkalinity of the tear film (tear pH). is also described herein. Tear pH, reflecting the acidity or alkalinity of the tear film, is a vital parameter in assessing ocular surface health. The normal range of tear pH in a healthy individual typically falls within a slightly acidic to slightly alkaline range. The average tear pH is around 7.4. However, in certain ocular conditions or illnesses, tear pH can deviate from the normal range. For example, in dry eye syndrome or ocular surface inflammation, the tear pH can decrease to as low as 6.0 or even lower. This acidic shift in tear pH is associated with increased tear osmolarity, decreased buffering capacity, and inflammation. On the other hand, tear pH values can occasionally rise above the normal range. As in certain types of ocular infections or microbial keratitis, tear pH may become more alkaline, exceeding 8.0. Therefore, pH sensing is considered as a valuable diagnostic tool.

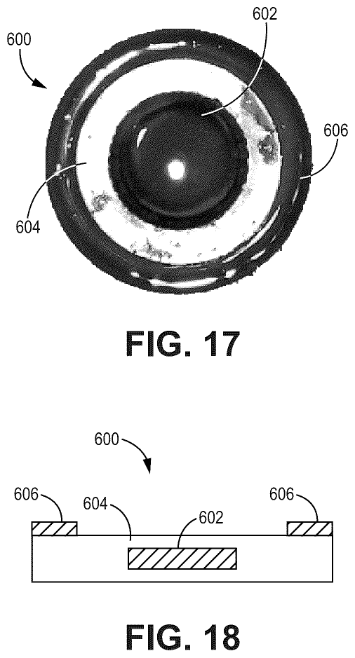

As illustrated in FIG. 17, the contact lens 600 has a central region 602 that is sized, shaped and arranged to cover the pupil of the eye in which the contact lens 600 is disposed. The central region is dyed to provide color filtering. The dyed central region 602 is circumferentially surrounded by a first region 604 that is clear. An annular second region 606 is separated from and surrounds the dyed central region 602. The second region 606 contains a pH sensitive dye, such as neutral red dye (amniodimethylamniotoluamniozine hydrochloride). The dyed central region 602 may also contain the same pH sensitive dye.

In one example, the contact lens 600 is formed of materials containing 2-hydroxyethyl methacrylate (HEMA) and a monomer, polyethylene glycol dimethacrylate (PEGDA) as a cross-linker, and diphenyl (2,4,6-trimethylbenzoyl) phosphine oxide (TPO) as a photoinitiator. A first material making up the bulk of the contact lens 600 that forms the clear first region 604 is formed of a first mixture of HEMA and PEGDA in a 1:1 ratio with 5% TPO by volume. The dyed central region 602 and the dyed second region 606 are made up of a second material that includes a second mixture of HEMA and PEGDA in a 10:1 ratio with 1% TPO by volume that is mixed with a third mixture of 75% neutral red dye and 25% deionized water in a 4:1 ratio of the second mixture to the third mixture.

It is worth noting that TPO is responsible for the low transmission observed in the range of 400-430 nm. The low transmission in the spectrum band 400-500 nm can be attributed to the high concentration of the neutral red dye.

The contact lens 600 may be formed by an additive manufacturing process using an additive manufacturing machine such as a 3D printer 400 as shown in FIG. 15. A CAD model of the contact lens 600 including the dyed central region 602, first region 604, and second region 606 may be prepared using a software program, such as SOLIDWORKS.

The CAD model is converted to instructions for the 3D printer 400, e.g., a WANHAO D8DLP-based 3D printer manufactured by WANHAO of Zhejiang, Peoples Republic of China. The 3D printer 400 may be paused at the required time steps while printing the second region 604 of the contact lens 600 with the first material. Pausing causes the printing process to stop. The build plate 402 of the 3D printer 400 is raised to allow access to the in-process contact lens 600. The liquid resin in the vat is removed and replaced by a second material. The in-process contact lens 600 sticking onto the build plate 402 is also cleaned to remove traces of resin sticking onto it. The in-process contact lens 600 is cleaned to prevent mixing of previously used material with the new material poured into the vat. The in-process contact lens 600 should be cleaned very carefully, as rough handling can cause it to detach from the build plate 402. The in-process contact lens 600 may be cleaned by running isopropyl alcohol (IPA) over it and then wiping it dry. The printing process was then resumed, thus causing the second region 606 and the central region 602 of the contact lens 600 to be printed with the second material. The 3D printer may be paused again to change the second material in the vat to the first material before printing another layer of the first material over the central region 602. The contact lens 600 may be removed from the build plate 402 and cleaned using a sonication process for 20 min while immersed in IPA. The sonication process removes traces of uncured resin that may still be attached to the contact lens 600, making the surfaces of the contact lens 600 smooth and clean. Thorough cleaning after printing greatly improved the contact lens' 600 optical transmission, which is crucial for ophthalmic devices.

The dyed second material may be immersed in a solution with the suitable pH to obtain the desired color of the central region 602 as it is printed onto the contact lens 600. The second material of the dyed second material of the second region 606 is printed onto an outer surface of the contact lens 600 so that it can be exposed to the tear film. After the dyed second material forming the central region 602 is printed into the contact lens 600, it is then encapsulated by printing a layer of the first material over it as shown in FIG. 18 to seal the central region 602 from contact with the tear film and ensure that the color of the central region remains unchanged due to exposure to a tear film or other solution a different pH.

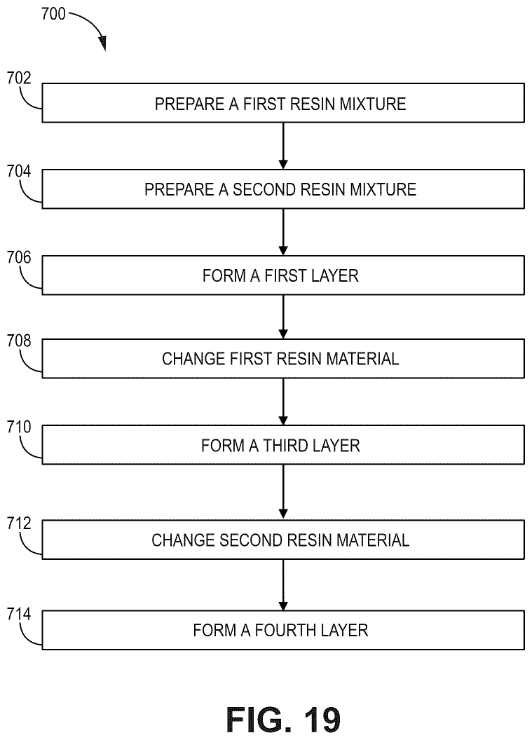

A method 700 of manufacturing an ophthalmic contact lens 600 using an additive manufacturing process is shown in FIG. 19. The method 700 includes the steps of:

STEP 702, PREPARE A FIRST RESIN MIXTURE, includes preparing a first resin mixture including HEMA, PEGDA and a photoinitiator, such as TPO.

STEP 704, PREPARE A SECOND RESIN MIXTURE, includes preparing a second resin mixture of HEMA, PEGDA, the photoinitiator, and a pH sensitive dye. A ratio of HEMA to PEGDA is higher in the second resin mixture than the first resin mixture and a volume of photoinitiator in the second resin mixture is less than the is less than a volume of photoinitiator in the second resin mixture. For instance, the first resin mixture may contain HEMA and PEGDA in a ratio of about 1:1 and about 5% TPO by volume. The second resin mixture may contain HEMA and PEGDA in a ratio of about 10:1 and about 1% TPO by volume. The pH sensitive dye may be a third mixture of 75% neutral red dye and 25% deionized water in a ratio of the second mixture to the third mixture of about 4:1.

STEP 708, FORM A FIRST LAYER, includes forming a first layer of the contact lens 600, using an additive manufacturing apparatus, e.g., the 3D printer 400, by dispensing and curing the first resin mixture.

STEP 710, CHANGE FIRST RESIN MATERIAL, includes pausing the additive manufacturing apparatus, cleaning the first layer, and replacing the first resin mixture with the second resin mixture.

STEP 712, FORM A SECOND LAYER, includes forming a second layer of the contact lens 600, over the first layer using the additive manufacturing apparatus by dispensing and curing the second resin mixture onto an outer surface of the first layer.

STEP 714, FORM A THIRD LAYER, includes forming a third layer of the contact lens, using the additive manufacturing apparatus by dispensing and curing the second resin mixture onto a central region of the first layer. The second resin mixture may be immersed in a solution with a suitable pH to obtain a desired color of the third layer as it is formed onto the first layer.

STEP 716, CHANGE SECOND RESIN MATERIAL, includes pausing the additive manufacturing apparatus, cleaning the second layer, and replacing the second resin mixture with the first resin mixture.

STEP 718, FORM A FOURTH LAYER, includes forming a fourth layer of the contact lens 600, over the third layer using the additive manufacturing apparatus by dispensing and curing the first resin mixture such that the third layer and the first layer encapsulate the second layer, thereby encapsulating the third layer and inhibiting color change by protecting the third layer from exposure to a tear film or other solution having a different pH than the solution used in STEP 714.

While the central region 602 and the second region 606 in the illustrated example both formed of the same material containing a pH sensitive dye, alternative embodiments of the contact lens 600 may be envisioned in which the central region 602 is formed of a different material containing another type of dye, e.g., a pH sensitive dye different than neutral red dye or non-pH sensitive dye, such as a carboxytetramethylrhodamine dye.

The contact lens 600 and method 700 beneficially offer a contact lens for treating CVD and indicating tear pH that is formed of only two different materials, thereby simplifying the fabrication process. The contact lens 600 also provides for tuning the color of the central region 602 by exposing the color to a solution with a particular pH value to cause the neutral red dye to have a desired color prior to encapsulation.

In some aspects, the techniques described herein relate to a method of manufacturing an ophthalmic contact lens, including: a) preparing a first resin mixture including HEMA, PEGDA and a photoinitiator; b) preparing a second resin mixture including HEMA, PEGDA, a photoinitiator, and a pH sensitive dye, wherein a ratio of HEMA to PEGDA is higher in the second resin mixture than the first resin mixture and a volume of photoinitiator in the second resin mixture is less than the is less than a volume of photoinitiator in the second resin mixture; c) forming a first layer of the contact lens using an additive manufacturing apparatus by dispensing and curing the first resin mixture; and d) forming a second layer of the contact lens onto the first layer using the additive manufacturing apparatus by dispensing and curing the dispensed second resin mixture onto an outer surface of the first layer.

In some aspects, the techniques described herein relate to a method, wherein the photoinitiator is TPO.

In some aspects, the techniques described herein relate to a method, wherein the first resin mixture contains HEMA and PEGDA in a ratio of about 1:1 and wherein the first resin mixture contains about 5% TPO by volume.

In some aspects, the techniques described herein relate to a method, wherein the second resin mixture contains HEMA and PEGDA in a ratio of about 10:1 and wherein the second resin mixture contains about 1% TPO by volume.

In some aspects, the techniques described herein relate to a method, wherein the pH sensitive dye contains neutral red dye and deionized water in a ratio of about 4:1.

In some aspects, the techniques described herein relate to a method, further including: e) forming a third layer of the contact lens using the additive manufacturing apparatus by dispensing onto a central region of the first layer and curing the dispensed second resin mixture; and f) forming a fourth layer of the contact lens using the additive manufacturing apparatus by dispensing the first mixture such that the third layer and the first layer encapsulate the second layer and curing the dispensed first resin mixture.

In some aspects, the techniques described herein relate to a method, further including: pausing the additive manufacturing apparatus, cleaning the first layer, and replacing the first resin mixture with the second resin mixture between steps c) and d); and pausing the additive manufacturing apparatus, cleaning the second layer, and replacing the second resin mixture with the first resin mixture between steps e) and f).

In some aspects, the techniques described herein relate to a method, wherein the second resin mixture is immersed in a solution with a suitable pH to obtain a desired color of the third layer as it is printed onto the first layer.

In some aspects, the techniques described herein relate to a method, wherein a curing time of the first and second layers is between 20 and 45 seconds.

In some aspects, the techniques described herein relate to an ophthalmic contact lens, including: a clear first region formed of a first material HEMA, PEGDA and a photoinitiator; and a dyed second region formed of second material containing HEMA, PEGDA, a photoinitiator, and a pH sensitive dye, wherein a ratio of HEMA to PEGDA is higher in the second resin mixture than the first resin mixture and a volume of photoinitiator in the second resin mixture is less than the is less than a volume of photoinitiator in the second resin mixture.

In some aspects, the techniques described herein relate to an ophthalmic contact lens, wherein the second region is disposed on an outer surface of the first region, thereby exposing the second region to a tear film when the contact lens is worn.

In some aspects, the techniques described herein relate to an ophthalmic contact lens, wherein the first region is formed in a disc shape.

In some aspects, the techniques described herein relate to an ophthalmic contact lens, wherein the photoinitiator is TPO.

In some aspects, the techniques described herein relate to an ophthalmic contact lens, wherein the first region contains HEMA and PEGDA in a ratio of about 1:1 and wherein the first resin mixture contains about 5% TPO by volume.

In some aspects, the techniques described herein relate to a method, wherein the second region contains HEMA and PEGDA in a ratio of about 10:1 and wherein the second resin mixture contains about 1% TPO by volume.

In some aspects, the techniques described herein relate to an ophthalmic contact lens, wherein the pH sensitive dye is amniodimethylamniotoluamniozine hydrochloride.

In some aspects, the techniques described herein relate to an ophthalmic contact lens, wherein the pH sensitive dye contains neutral red dye and deionized water in a ratio of about 4:1.

In some aspects, the techniques described herein relate to an ophthalmic contact lens, further including: a central region formed of the second material and disposed on the first region, wherein the central region is encapsulated between the first region and a layer of the first material, thereby inhibiting contact of the central region with a tear film when the contact lens is worn.

In some aspects, the techniques described herein relate to an ophthalmic contact lens, wherein the second region is formed in an annular shape.

In some aspects, the techniques described herein relate to an ophthalmic contact lens, wherein the second region is formed closer to a periphery of the first region than the central region.

While the contact lenses described herein are hydrogel contact lenses formed primarily from HEMA material, alternative embodiments may be silicon hydrogel or hard contact lenses with a thin layer of HEMA material containing the tinted regions described above.

While embodiments have been described with reference to an exemplary embodiment(s), it will be understood by those skilled in the art that various changes may be made, and equivalents may be substituted for elements thereof without departing from the scope of the embodiments. In addition, many modifications may be made to adapt a particular situation or material to the teachings of the embodiments without departing from the essential scope thereof. Therefore, it is intended that the entire embodiments are not limited to the disclosed embodiment(s), but that embodiments include all that fall within the scope of the appended claims.

1. A method of manufacturing an ophthalmic contact lens, comprising:
a) preparing a first resin mixture including HEMA, PEGDA and a photoinitiator;
b) preparing a second resin mixture including HEMA, PEGDA, a photoinitiator, and a pH sensitive dye, wherein a ratio of HEMA to PEGDA is higher in the second resin mixture than the first resin mixture and a volume of photoinitiator in the second resin mixture is less than the is less than a volume of photoinitiator in the second resin mixture;
c) forming a first layer of the contact lens using an additive manufacturing apparatus by dispensing and curing the first resin mixture; and
d) forming a second layer of the contact lens onto the first layer using the additive manufacturing apparatus by dispensing and curing the dispensed second resin mixture onto an outer surface of the first layer.

2. The method according to claim 1, wherein the photoinitiator is TPO.

3. The method according to claim 1, wherein the first resin mixture contains HEMA and PEGDA in a ratio of about 1:1 and wherein the first resin mixture contains about 5% TPO by volume.

4. The method according to claim 3, wherein the second resin mixture contains HEMA and PEGDA in a ratio of about 10:1 and wherein the second resin mixture contains about 1% TPO by volume.

5. The method according to claim 1, wherein the pH sensitive dye contains neutral red dye and deionized water in a ratio of about 4:1.

6. The method according to claim 1, further comprising:
e) forming a third layer of the contact lens using the additive manufacturing apparatus by dispensing onto a central region of the first layer and curing the dispensed second resin mixture; and
f) forming a fourth layer of the contact lens using the additive manufacturing apparatus by dispensing the first mixture such that the third layer and the first layer encapsulate the second layer and curing the dispensed first resin mixture.

7. The method according to claim 6, further comprising:
pausing the additive manufacturing apparatus, cleaning the first layer, and replacing the first resin mixture with the second resin mixture between steps c) and d); and
pausing the additive manufacturing apparatus, cleaning the second layer, and replacing the second resin mixture with the first resin mixture between steps e) and f).

8. The method according to claim 6, wherein the second resin mixture is immersed in a solution with a suitable pH to obtain a desired color of the third layer as it is printed onto the first layer.

9. The method according to claim 1, wherein a curing time of the first and second layers is between 20 and 45 seconds.

10. An ophthalmic contact lens, comprising:
a clear first region formed of a first material HEMA, PEGDA and a photoinitiator; and
a dyed second region formed of second material containing HEMA, PEGDA, a photoinitiator, and a pH sensitive dye, wherein a ratio of HEMA to PEGDA is higher in the second resin mixture than the first resin mixture and a volume of photoinitiator in the second resin mixture is less than the is less than a volume of photoinitiator in the second resin mixture.

11. The ophthalmic contact lens according to claim 10, wherein the second region is disposed on an outer surface of the first region, thereby exposing the second region to a tear film when the contact lens is worn.

12. The ophthalmic contact lens according to claim 10, wherein the first region is formed in a disc shape.

13. The ophthalmic contact lens according to claim 10, wherein the photoinitiator is TPO.

14. The ophthalmic contact lens according to claim 10, wherein the first region contains HEMA and PEGDA in a ratio of about 1:1 and wherein the first resin mixture contains about 5% TPO by volume.

15. The ophthalmic contact lens according to claim 14, wherein the second region contains HEMA and PEGDA in a ratio of about 10:1 and wherein the second resin mixture contains about 1% TPO by volume.

16. The ophthalmic contact lens according to claim 10, wherein the pH sensitive dye is amniodimethylamniotoluamniozine hydrochloride.

17. The ophthalmic contact lens according to claim 10, wherein the pH sensitive dye contains neutral red dye and deionized water in a ratio of about 4:1.

18. The ophthalmic contact lens according to claim 10, further comprising:
a central region formed of the second material and disposed on the first region, wherein the central region is encapsulated between the first region and a layer of the first material, thereby inhibiting contact of the central region with a tear film when the contact lens is worn.

19. The ophthalmic contact lens according to claim 18, wherein the second region is formed in an annular shape.

20. The ophthalmic contact lens according to claim 19, wherein the second region is formed closer to a periphery of the first region than the central region.
